(19) United States
(12) Patent Application Publication
(10) Pub. No.: US 2014/0124356 A1
(43) Pub. Date: May 8, 2014

(54) PROCESS FOR SOLAR THERMAL ENERGY PRODUCTION

(71) Applicant: BASF SE, Ludwigshafen (DE)

(72) Inventors: Christian MUELLER, Mannheim (DE); Otto MACHHAMMER, Mannheim (DE); Peter ZEHNER, Weisenheim am Berg (DE)

(73) Assignee: BASF SE, Ludwigshafen (DE)

(21) Appl. No.: 14/069,759

(22) Filed: Nov. 1, 2013

Related U.S. Application Data
(60) Provisional application No. 61/723,790, filed on Nov. 8, 2012.

(51) Int. Cl. C02F 1/14; F24J 2/34

(52) U.S. Cl. CPC C02F 1/14; F24J 2/345
USPC 203/10; 126/714; 126/640; 202/234

(57) ABSTRACT

The present invention relates to a process for solar thermal energy production in which switching between daytime and nighttime operation is possible, and also to a device for solar thermal energy production. The present invention relates, in particular, to the use of the process and of the device for producing drinking water or service water.

The present invention relates to a process for solar thermal energy production in which switching between daytime and nighttime operation is possible, and also to a device for solar thermal energy production. The present invention relates, in particular, to use of the process and of the device for producing drinking water or service water.

In view of rising prices and disappearing resources worldwide, the continuing dealing over energy becomes more and more important. The growing energy requirement with restricted natural resources gives energy suppliers, industry and consumers the problem of using energy as efficiently and in an environmentally friendly manner as possible. In this case, energy efficiency relates to all forms of energy conversion. In particular, solar energy is continuing to gain in importance also in view of the policy of forced energy change.

The worldwide energy demand makes up a fraction of the energy of the solar radiation incident on the Earth's surface. Even taking into account the considerable fluctuation in latitude, height and weather, solar energy thus exhibits the greatest potential of the renewable energies. In order to make use of this energy source, particularly photovoltaic, that is to say conversion of solar energy into electrical energy, and solar thermal power, that is to say conversion of solar energy into thermal energy, are available.

Thermal solar plants or solar thermal collectors are principally used in the private sector in the context of domestic engineering for warm water generation, heating and air conditioning of buildings. In the industrial sector, generally plants having more than 20 m² of collector area are used for producing process heat in the temperature range up to 100° C. or somewhat above, for example for accelerating biological and chemical processes in biomass processing or in the chemical industry or for heating air.

Industrial use takes place in thermal solar power plants. Most of these plants use concentrating collectors for focusing the sun's rays to an absorber point or an absorber line in which temperatures of about 400° C. to over 1000° C. can be achieved. This heat is then either used as industrial process heat or converted into power via generators (solar thermal power generation). Solar towers are one example in which individual flat mirrors track the sun in such a manner that light is concentrated on the actual absorber at the peak of a tower. By means of this process, temperatures of above 1000° C. can be generated. As heat carrier medium, air, oils or liquid sodium are used. Since concentrating systems are directed towards direct solar irradiation, they are only used in dry regions rich in sunlight.

In addition, a Salinity Gradient Solar Pond, also termed a Solar Pond, is known from the prior art. This is a tank filled with saltwater that is used as collector and store for solar heat. The storage action is based on a stable temperature layering of the saltwater which may be used on account of the density, temperature and concentration gradients between ground and surface of the tank. Disadvantages of such solar ponds are the low storage density and the associated high space requirement. In addition, the action of such a solar pond is based on a comparatively high salt content of the water and is not applicable to freshwater and brackish water.

The object, therefore, underlying the present invention is to provide a simple and efficient process for producing energy from solar radiation, which process makes minor requirements of the location, in particular with respect to space requirement and available water quality. In addition, it should permit integration in a simple manner into other processes for diverse fields of use, in particular for producing drinking water or service water. The process should not require either complex and expensive crude-water pretreatment or high capital expenditure. In addition, it should be suitable for use in remote areas or in developing countries. A corresponding device should be manufactured with inexpensive materials but nevertheless be reliable in operation and insensitive to fouling or scaling.

This object is achieved according to the invention by a process for solar thermal energy production in which switching between daytime and nighttime operation is possible. In the daytime operation
a) a solar liquid is provided continuously,
b) heat energy is fed by means of solar thermal power to the solar liquid provided, wherein the solar liquid is heated,
c) a part of the solar liquid heated in step b) is withdrawn as heating medium,
d) the remaining part of the solar liquid heated in step b) is stored in a storage device, and
e) colder solar liquid is displaced from this storage device by the part of the heated solar liquid that is to be stored.

In nighttime operation
f) the same solar liquid as in step a) in daytime operation is continuously provided,
g) the solar liquid provided is introduced into the storage device in such a manner that
h) the heated solar liquid obtained in step d) and stored is displaced from the storage device and
j) is withdrawn as heating medium.

Solar thermal energy production, here and hereinafter also termed solar thermal energy for short, is taken to mean the conversion of the energy of solar radiation into utilizable thermal energy, that is to say into heat.

Daytime operation, in the context of the present invention, denotes the times at which the solar radiation is intensive enough in order to feed the heat energy efficiently to the solar liquid. Nighttime operation, in the context of the present invention, in contrast, denotes the times at which the solar radiation is too low in order to feed the heat energy efficiently to the solar liquid.

The efficiency of the heat supply may be assessed on the basis of the degree of efficiency. The degree of efficiency indicates what proportion of the incident solar radiation power can be converted into utilizable heat power. It is not a constant, but is dependent on the respective radiation power of the sun, which in turn is dependent on the time of day and season. In addition, the temperature difference between the solar liquid and the surroundings plays a role. The degree of efficiency averaged over the daytime operation is, for example, at least 40%, preferably at least 50%.

A solar liquid, in the context of the present invention, is taken to mean a liquid heat carrier which can take up, store and release again the solar energy in the form of heat. By means of the solar liquid, heat can be transported from a site of relatively high temperature to a site of relatively low temperature. The solar liquid used can therefore also be used as a heating medium. Preferably, the solar liquid used is biologically harmless, non-toxic, non-corrosive and non-irritating.

In particular, the solar liquid is substantially water. Water, owing to its high specific heat capacity or its high specific enthalpy of evaporation, is a very good heat carrier. In addition, the low albedo values of water surfaces ensure good absorption of the solar radiation. Water can be used both in open and in closed systems. The water used as solar liquid can be water of any desired origin. Particularly preferably, naturally occurring water is used, such as seawater, brackish water, surface water of lakes, rivers, etc., wastewater from other processes or mixtures thereof. Optionally, the water can be admixed with various additives that improve the physical, chemical and/or rheological properties for the respective application.

In a preferred embodiment of the process according to the invention, the water provided as solar liquid has a salinity in the range from 0.5% to 30.0%.

Salinity, here and hereinafter, is taken to mean the salt content. The salinity, in the context of the present invention, is stated in percent. A salinity of 1% is equivalent to 10 g of salt per 1 kg of solar liquid.

The salt content of naturally occurring water, such as, for example, in rivers, salt lakes, seas, etc., fluctuates, as does the salt content of industrial wastewater. For example, waters that are suitable for use in the process according to the invention are brackish water, seawater, industrial wastewater of mixtures thereof. The saltwater used in the process according to the invention has, for example, a salinity of at least 0.5%, particularly preferably of at least 3%, and at most 30%.

Preferably, the saltwater used according to the invention as solar liquid comprises at least 1% by weight, based on the total content, of salt, salts of monovalent cations and monovalent anions. Preferably, the monovalent cations are selected from Li⁺, Na⁺, K⁺, NH₄⁺ and mixtures thereof. Preferably, the monovalent anions are selected from F⁻, Cl⁻, Br⁻, I⁻ and mixtures thereof. Particularly preferably, the saltwater used according to the invention comprises NaCl at at least 50% by weight, especially at at least 75% by weight and in particular at at least 90% by weight. The saltwater used according to the invention can, if desired, comprise salts of divalent, trivalent and/or higher-valent cations and/or anions. These include, in particular, the fractions of the usual ions present in the water used.

In the provision of saltwater for the process according to the invention, optionally a pretreatment of the saltwater is to be provided. This can be a mechanical pre-purification in which the saltwater is freed from solids in advance. Separating off solids from the saltwater can proceed, for example, by means of filtration or in a hydrocyclone. A chemical and/or biological pretreatment can also proceed in order to decrease or avoid the growth of algae, microbes, etc.

In another preferred embodiment of the process according to the invention, the water provided as solar liquid is contaminated by suspended matter.

In the provision of water that is contaminated by suspended matter for the process according to the invention, optionally, a pretreatment of the water is to be provided. This can be a mechanical pre-purification, in which the contaminated water is freed in advance from coarse solids. Separating off coarse solids from the saltwater can proceed, for example, by means of sieves or rakes. A chemical and/or biological pretreatment can also proceed in order to decrease or avoid the growth of algae, microbes, etc., for example.

In a particularly preferred embodiment of the process according to the invention, the water provided as solar liquid is contaminated by microorganisms, in particular bacteria. The water used as solar liquid can, as an alternative or in addition to salts, comprise impurities in the form of organic compounds, such as, for example, bacteria, viruses, fungi, spores, inter alia.

In the provision of microbially contaminated water for the process according to the invention, a pretreatment of the water is optionally to be provided. This can be a mechanical pre-purification in which the microbially contaminated water is freed in advance from solids. The separation of solids from the microbially contaminated water can proceed, for example, by means of filtration or in a hydrocyclone.

In a preferred embodiment of the process according to the invention, the solar liquid, during the heating by means of solar thermal power, is heat-insulatingly covered from the surroundings in such a manner that energy input into the solar liquid by radiation is possible.

In order to be able to utilize the introduced heat independently of the current solar irradiation, the introduced heat is stored in a storage device. The storage device, also termed a store or reservoir, is a natural or artificial store for solar liquid, in particular for surface water, rainwater, utility water and/or drinking water. Important features of the storage device are storage capacity and heat losses. The storage capacity is proportional to the storage volume, to the heat capacity of the storage medium and to the usable temperature difference. The solar liquid, in particular water, serves as storage medium. The degree of utilization of the store is determined from the ratio of the stored usable energy and the energy fed to the store. In conventional storage devices, the degree of utilization decreases with time because heat is released to the surroundings. The heat losses are dependent on the surface area of the store, the wall material and thickness thereof, the temperature difference between storage medium and surroundings. The energy storage density describes the maximum storable energy (heat capacity) of a store, based on the volume thereof (or mass thereof) under specified conditions.

In order to minimize the heat losses, the storage device can be constructed so as to be thermally insulated. The storage device is preferably designed for a high temperature level, since the solar liquid, especially in summer and in hot areas, reaches temperatures of above 90° C.

In a preferred embodiment of the process according to the invention, the fill height of the storage device can be controlled.

The volume of the storage device may be controlled via the fill level. Thereby, in turn, the storage capacity may be adjusted taking into account further parameters such as, for example, heat introduction, heating requirement and/or energy storage density.

The volume of the storage device is adjusted, for example, in the range from 10⁻² m³ to 10⁵ m³. The storage device in this case has, for example, a ratio of surface area to volume in the range from 0.1 m⁻¹ to 600 m⁻¹.

In a preferred embodiment of the process according to the invention, the fill height of the heat-absorbing region can be controlled.

The heat-absorbing region, here and hereinafter, denotes the region in which incident solar radiation impacts the solar liquid and is absorbed thereby. In the heat-absorbing region, the solar liquid heats up. Suitably, the heat-absorbing region is heat-insulatingly covered from the surroundings. In particular, a heat-absorbing region has an open liquid circuit through which the solar liquid that is to be heated flows.

The volume of the heat-absorbing region may be controlled via the fill level. Thereby, in turn, the temperature of the solar liquid may be adjusted before entry into the storage device, taking into account further parameters, such as, for example, the intensity of the solar radiation and/or heating requirement.

The heat-absorbing region preferably has a maximum fill level in the range from 1 mm to 500 mm.

In a special embodiment, the storage device and the heat-absorbing region are separated from one another by a heat-insulating float. The volumes of the heat-absorbing region and of the storage device may be controlled thereby in direct dependence on one another.

The ratio of the volumes of heat-absorbing region to storage device is, in daytime operation, according to a suitable embodiment, in the range from 1:5 to 1:500.

In a preferred embodiment of the process according to the invention, the volume of the heat-absorbing region can be minimized in the nighttime operation.

In a preferred embodiment of the process according to the invention, the heat-absorbing region, in the daytime operation, has a fill height of not less than 1 mm of the solar liquid.

In a preferred embodiment of the process according to the invention, the heat-absorbing region is insulated from the storage device in such a manner that heat transfer between these regions can take place substantially only via the introduction of the solar liquid. Such an insulation also minimizes the heat losses in nighttime operation.

Generally, the solar energy is introduced in the upper part of the storage device. In order to minimize heat losses, the heat-absorbing region is advantageously arranged directly above the storage device, wherein the heat-absorbing region and the storage device are separated from one another by a heat-insulating appliance.

In a suitable embodiment of the process according to the invention, the solar liquid is deflected two or more times during flow through the storage device.

For example, the flow is deflected two times to ten times, preferably four times to six times. The deflection proceeds each time in the range from 90° to 180°. Via such a repeated flow deflection, a stable temperature layering should be counteracted in the solar liquid (thermocline). This embodiment is suitable, in particular, when saltwater is used as solar liquid.

In a preferred embodiment of the process according to the invention, the solar liquid that is withdrawn in steps c) and j) as heating medium is fed to an appliance for decoupling utilizable heat.

Decoupling utilizable heat, in the context of the present invention, is taken to mean energy transport across at least one thermodynamic system boundary. The energy transfer proceeds owing to a temperature gradient, and so one speaks of heat exchange between thermally coupled systems. A suitable appliance for decoupling utilizable energy is, quite generally, a heat exchanger.

In a preferred embodiment of the process according to the invention, the solar liquid displaced in step d), after leaving the storage device, is returned at least in part in step b). For this purpose, the solar liquid withdrawn from the storage device is returned to the heat-absorbing region. Thus, the temperature of the solar liquid in the storage device may be increased and thereby the available utilizable heat may be increased.

In a preferred embodiment of the process according to the invention, the fill level of the storage device is controlled in dependence on the temperature of the solar liquid.

The invention also relates to the use of the process according to the invention in a process for producing drinking water and/or service water from saltwater.

Alternatively, the process according to the invention can be used in a process for producing drinking water and/or service water from contaminated water.

The present invention likewise relates to a continuous process for the production of pure water from raw water, in which
i) a raw water is provided that comprises at least one non-vaporizable component,
ii) the raw water provided is passed as cooling medium into a heat exchanger,
iii) heat is additionally supplied using a process according to the invention for solar thermal energy production to the raw water heated in the heat exchanger,
iv) the raw water from step iii) is fed to an evaporation zone,
v) a carrier gas suitable for water vapor is provided,
vi) the carrier gas is contacted in the evaporation zone with the raw water in countercurrent, wherein the carrier gas takes up water vapor from the raw water,
vii) the raw water obtained in step vi) and enriched in the at least one non-vaporizable component is withdrawn from the evaporation zone,
viii) the water vapor-loaded carrier gas is fed from the evaporation zone to the heat exchanger and cooled in countercurrent to the raw water, wherein the water vapor present in the carrier gas is in part condensed out,
ix) the carrier gas depleted in water vapor is passed out of the heat exchanger,
x) the water vapor that is condensed out is withdrawn from the heat exchanger as pure water.

The process according to the invention for the production of pure water from raw water serves for the removal of at least one undesirable contaminant that is non-vaporizable under the process conditions from the raw water feed. In this case, a pure water depleted in the undesirable component(s) is obtained. In addition, a raw water enriched in the undesirable component(s) is obtained.

The raw water used according to the invention can comprise at least one non-vaporizable component in dissolved or non-dissolved form. The non-vaporizable components present in the raw water can be organic or inorganic substances. The non-vaporizable components present in the raw water can be liquid or solid at standard conditions (20° C., 1 atm). The non-vaporizable components are generally distinguished by a very low vapor pressure. Non-dissolved, solid, non-vaporizable components are preferably present in the raw water in suspension. Non-dissolved, liquid, non-vaporizable components are preferably present in the raw water in emulsified form.

Non-vaporizable components which can be removed by the process according to the invention are, for example, relatively large solids, floating matter, suspended matter, oils, fats, organic impurities different from oils and fats, microorganisms, salts, etc. and mixtures thereof.

Since the process according to the invention comprises a vaporization of the raw water, it is suitable for producing both drinking water and service water for various fields of application. Measures which are optionally additionally required, such as the supplementation of dissolved salts in any physiologically acceptable amount for the treatment of drinking water, are within the competence of those skilled in the art.

In a special embodiment, the process according to the invention serves for producing fresh water from saltwater.

Usually, a solution of salts in water is designated saltwater, for example seawater, brackish water, salt-comprising river water or spring water, or salt-loaded wastewater. The salt content of naturally occurring water, such as, for example, in rivers, salt seas, lakes etc. varies just as the salt content of industrial wastewaters. Waters particularly suitable for use in the process according to the invention are brackish water, seawater, salt-comprising spring water, industrial wastewater, or mixtures thereof. The saltwater used in the process according to the invention has, for example, a salt content of at least 0.5%, preferably of at least 3%. Preferably, saltwater having a salt content of at most 20% is used, for example with a salt content in the range from 1 to 10%, preferably in the range from 3 to 5%.

In the provision of saltwater for the process according to the invention, optionally, a pretreatment of the saltwater is to be provided. This can be a mechanical pre-purification in which the saltwater is freed from solids before entry into the heat exchanger. The separation of solids from the saltwater can proceed, for example, by means of filtration or in a hydrocyclone.

In a particularly preferred embodiment of the process according to the invention, salt-comprising surface water is used. In this embodiment, optionally, the physical filter action of the substrate of the surface water, for example, the sea bottom, the lake bottom, etc., can be utilized for the pre-purification of the raw water. In particular, the filter action of sandy substrates may be used advantageously.

For this purpose, for example, a suitable tube for the raw water supply from a point within the body of water can be laid in the substrate with a sufficient distance from the bank. In the region of the water-overflow region of the body of water, the tube is constructed to be porous for this purpose. Thus, blocking of the raw water supply can be avoided and simultaneously a raw water having a low content of solids can be provided.

A chemical and/or biological pretreatment can also proceed, in order to decrease or avoid, for example, the growth of algae, microber, etc.

Fresh water, in contrast to saltwater, is that fraction of water freely available on the Earth, that is to say not bound, for example in plants, in which salts are not dissolved or are dissolved only to a small extent. Low-saltwater having a salt content of less than 0.1%, independently of its state of matter, is termed fresh water.

Fresh water in the context of the present invention is to be taken to comprise both process water and drinking water. Process water (also termed service water or utility water) is water that serves for a specific technical, commercial, agricultural or domestic use. Process water, in contrast to drinking water, is not provided for human consumption, but should conform to a certain minimum hygiene. In each case, it must satisfy the technological requirements of the respective process. Process water is a type of service water necessary for operating or maintaining an industrial process. Frequently, in these applications, the salt content of the fresh water used is critical.

Drinking water, in contrast, demands high quality requirements such that it is suitable for human consumption, in particular for drinking and for preparing dishes. A certain salt content is necessary in the use as drinking water, and so the required salt content of drinking water may be set according to the invention.

The fresh water obtained according to the invention preferably has a salt content of a maximum of 0.1%, preferably in the range from 0.01 to 0.05%. The residual salt content is due, for example, to the droplets entrained from the saltwater in the course of evaporation (step vi).

The carrier gas used in the process according to the invention takes up water vapor owing to temperature elevation and then releases it again owing to temperature fall. The carrier gas enriched or saturated with water vapor is hereinafter also termed vapors. Suitable carrier gases are in principle all materials and mixtures of materials that are gaseous under the operating conditions of the process according to the invention. These include, for example, air, carbon dioxide and nitrogen and also mixtures thereof. In a preferred embodiment of the process according to the invention, the carrier gas is air. The water content of the carrier gas provided preferably does not exceed 70% by volume. It is, for example, in the range from 10% by volume to 45% by volume, preferably in the range from 20% by volume to 35% by volume.

In a preferred embodiment of the continuous process according to the invention for producing pure water from raw water, the water-depleted carrier gas is returned to the evaporation zone. In a suitable embodiment, the carrier gas can be transported through the evaporation zone and the condensation zone by means of natural convection. In a preferred embodiment, the transport of the carrier gas through the evaporation zone and the condensation zone is supported by a mechanical drive. Examples of suitable mechanical drives are aerators, blowers, fans, propeller drives and the like. Particularly preferably, the mechanical drive is a radial blower.

In step ii) and viii), for the condensation of pure water, especially fresh water, a suitable counterflow heat exchanger is used. Heat exchangers suitable for the process according to the invention, in which one medium is a liquid and the other medium is a gas, can differ very greatly with respect to the heat capacity per volume of the media. Generally—with respect to the volume—more gas than liquid must flow through the heat exchanger. In a suitable design, therefore, the raw water, especially the saltwater, is conducted as liquid coolant in tubes. In an equally suitable embodiment, the exchange area on the gas side is provided with structures increasing surface areas, such as, for example, cooling fins or plates. The heat exchanger is, for example, a tube heat exchanger, tube bundle heat exchanger, plate heat exchanger or micro heat exchanger. The heat exchanger is preferably made of a readily available material, such as, for example, steel, corrosion-resistant metal alloys, coated materials, plastics or combinations thereof.

Since the exchange surface facing the gas only comes into contact with vaporized pure water and therefore pure water that is somewhat uncritical with respect to possible corrosion, this exchange surface can comprise inexpensive materials, for example tinplate or materials such as are used for commercially available air coolers. This applies especially to a desalination process in which the exchange surface facing the gas only comes into contact with desalinated water.

For the region of the heat exchanger which comes into contact with the corrosive raw water, especially saltwater, generally corrosion-resistant materials are used. Such materials are known to those skilled in the art. These include metals such as stainless steels, bronzes, etc. Preferably, for the heat exchanger, a non-corrosion-resistant but inexpensive metal is used, and the regions of the heat exchanger contacting saltwater are coated, for example, with a corrosion-resistant plastic, oxides or ceramics. The coating is expediently selected in such a manner that it has a thermal conductivity resistance as low as possible, and in addition is resistant to deposits, scaling or fouling.

In a particularly preferred embodiment, conventional twin-wall sheets are arranged as heat exchangers. The heat exchanger may then be made, for example, from in each case a pair of parallel twin-wall sheets. In this design, the raw water is passed in each case between the two twin-wall sheets forming a pair, whereas the water-loaded carrier gas flows through the twin-wall sheets.

The twin-wall sheets used are preferably made of a plastic, in particular of an inexpensive plastic such as, for example, polyvinyl chloride.

Alternatively thereto, it is also possible to use a non-corrosion-resistant but cheap material in the heat exchanger, which is then replaced at relatively short intervals.

The choice, dimensioning and design of suitable heat exchangers is known to those skilled in the art.

In step vii), the concentrated raw water obtained in step vi) is taken off from the evaporation zone. The raw water taken off in step vii) is generally warmer than the raw water provided by a maximum of 25° C., preferably by a maximum of 15° C., and in particular by a maximum of 5° C. Therefore, it can be discharged directly into a body of water or a corresponding treatment appliance. If the concentrated raw water is warmer than the raw water provided by at least 10° C., preferably by at least 20° C., and in particular by at least 30° C., preheating of the raw water provided before entry into the heat exchanger in step b) can be provided using the concentrated raw water from step g). For this purpose, a heat exchanger suitable for raw water streams, especially saltwater streams, or another suitable appliance can be used.

If the pure water obtained according to the invention (i.e. in the case of a desalination process, the fresh water) is to be very largely desalinated for further use, for example having a salt content of at most 0.01%, optionally a demister can be provided prior to entry of the loaded carrier gas into the heat exchanger for condensation in step vii).

In a suitable embodiment of the process according to the invention, the pure water (fresh water) obtained in step x) is subjected to one or more treatment steps in order to obtain drinking water.

Drinking water is fresh water having a high degree of purity such that it is suitable for human consumption, in particular for drinking and for preparation of dishes. Drinking water must not comprise pathogenic microorganisms and should have a minimum concentration of minerals. The water treatment depends on the quality of the raw water, in the present case of the fresh water obtained by the process according to the invention. The treatment processes depend on the materials present in and to be removed from the raw water or fresh water. The usual chemical and/or physical treatment methods suitable for producing drinking water are known to those skilled in the art.

The present invention also relates to a device for solar thermal energy production which comprises
an appliance for feeding a solar liquid;
a solar collector having a heat-insulating covering which is substantially permeable to solar radiation;
a solar heat store;
a heat-insulating appliance which separates the solar collector and the solar heat store from one another; and
an appliance for withdrawing the heated solar liquid.

The solar collector in this case is arranged directly above the solar heat store.

A solar collector, also referred to as sun collector, is generally taken to mean a device for collecting energy present in sunlight. In the context of the present invention, a thermal solar collector is meant thereby which heats a solar liquid using the absorbed solar energy. Preferably, the solar collector is an open system in which the solar liquid that is to be heated flows directly through the solar collector.

The heat-insulating covering is generally made of a transparent material. It is preferably selected from glass, plastic film, plastic moldings lying loosely against one another such as, for example, balls, polymer gel or the like.

The solar rays incident through the heat-insulating covering impact, in the solar collector, the surface of the solar liquid. On the impact of the solar rays, virtually the entire spectral range of the light is absorbed. The heat is transferred to the solar liquid that is flowing through. Convective heat release from the heated solar liquid to the surroundings is minimized by the heat-insulating covering. Heat which, owing to the inherent temperature of the solar collector or of the solar liquid, is irradiated away by emission, can be retained, at least in part, preferably for the most part, likewise via the heat-insulating covering. The heat energy is transported to the solar heat store via the solar liquid.

The solar heat store is substantially a pool. It can either be a pool of natural origin, an artificially laid out pool or an open or closed container. Generally, the solar heat store is a short-time store in which heat arises discontinuously which is stored and released again, and so the solar heat store stores the heat only for a few hours or days. The storage volume must therefore be dimensioned in such a manner that an amount of heated solar liquid generally sufficient for four hours to four days, preferably for six hours to two days, in particular for 12 to 36 hours, can be taken up and provided at the temperature of use.

If the solar liquid is water, the solar heat store can be constructed as a horizontal or vertical water container.

Suitable materials for the wall of the solar heat store are generally selected from steel, stainless steel, temperature-resistant plastic such as, for example, polypropylene, polyethylene, PUR, combinations thereof and sandwich elements.

In a preferred embodiment of the device according to the invention, the solar heat store is at least partly insulated from the surroundings in the side and lower regions. Heat losses, particularly in nighttime operation and in the case of relatively long storage times, are intended to be minimized thereby. Suitable insulating materials are, for example, foam materials such as, for example, foam materials of polystyrene, polyethylene, polypropylene, melamine resin, or combinations thereof. If the solar heat store is a pool of natural origin, then of course natural insulation by sand, gravel, soil etc. can be used alternatively or in addition. Optionally, in this case, the wall of the solar heat store can comprise a watertight (plastic) film that prevents percolation of the heated solar liquid in the natural insulation.

Generally, the solar heat store is operated unpressurized. In this case, the solar heat store is operated at temperatures up to a maximum of 100° C. In the case of an unpressurized store, the solar heat store itself takes up the changing volume of the solar liquid resulting from the heating. A pressurized store can also be used. If a pressurized store is used, the volume change owing to the thermal expansion of the water must be taken up or eliminated via a corresponding pressure maintenance.

The selection of suitable materials and the dimensioning of such solar heat stores is within the competence of those skilled in the art.

If the device according to the invention is integrated into a system, for example, for producing service water or drinking water, an unpressurized store can optionally also be used as pressure maintenance appliance for this system. A precondition thereof is that the water level of the solar heat store is situated at the hydrostatic zero point of the system.

The solar collector is arranged directly above the solar heat store in such a manner that the solar collector and the solar heat store are separated from one another by the heat-insulating appliance. Via such an arrangement, advantageously, energy losses, both due to piping and due to the heat of the solar liquid being released in nighttime operation, may be minimized.

In particular, the solar liquid is substantially water. The water can be water of any desired origin. Particularly preferably, naturally occurring water such as seawater, brackish water, salt-comprising spring water, surface water of lakes, rivers etc., wastewater from other processes or mixtures thereof are used. Optionally, the water can be admixed with various additives that improve the physical, chemical and/or rheological properties for the respective application.

The water preferably has a salinity in the range from 0.5% to 30.0% and/or is contaminated by suspended matter and/or by microorganisms. The water used as solar liquid can comprise impurities in the form of organic compounds or microorganisms such as, for example, bacteria, viruses, fungi, spores inter alia. In the provision of saltwater and/or contaminated water for the process according to the invention, optionally a pretreatment of the water is to be provided. This can be a mechanical pre-purification in which the water is freed in advance from solids. Separating off solids from saltwater can proceed, for example, by means of filtration or in a hydrocyclone. A chemical and/or biological pretreatment can also proceed, in order, for example, to reduce or avoid the growth of algae, microbes, etc.

The appliance for feeding the solar liquid into the device comprises a seed line from an already existing, natural or artificially laid out reservoir of the solar liquid and a suitable conveying means, for example, a pump or a conveying screw such as, for example, an Archimedes screw. If the solar liquid is water, the reservoir can be a free-flowing body of water, for example a river or canal, or a static body of water, for example a lake or a collecting pool. It can be an above-ground body of water, such as an inland body of water or a sea, or else an underground body of water.

The feed line is substantially a pipe. Depending on the type of construction of the conveying means, in particular of the pump, the further fittings, for example shut-off fittings or throttling appliances, need to be provided on the feed line. In addition, generally a mechanical pre-purification such as, for example, a rake, a filter, a sieve, a hydrocyclone, another mechanical separator for removing solids, or a combination thereof is required. Optionally, a chemical and/or biological pre-purification can also be provided. In particular, a treatment can be provided with active ingredients that reduce the biological growth of algae, for example.

The device for withdrawal of the heated solar liquid is substantially a pipe on which suitable fittings, for example shut-off fittings or throttling appliances, are to be provided. Optionally, a suitable conveying means, for example a pump, is to be provided.

Since the pressure drops to be overcome are low and no coarse solid parts are present in the provided solar liquid, for conveying the solar liquid, in principle all types of pumps come into consideration. Typical structures are displacement pumps and centrifugal pumps in corrosion-resistant designs. The pump used for conveying the solar liquid can be driven by an electric motor or by an internal combustion engine, for example a gas or diesel engine. The electric motor, in a preferred embodiment, can be driven by solar energy, for example from locally installed solar cells. A suitable pump drive is also a Stirling engine which, for example, is fed with solar energy by a parabolic mirror. The pump can be selected according to economic and/or ecological aspects, taking into account the corrosivity of the solar liquid. The selection and design of suitable pumps is known to those skilled in the art.

The pipes, i.e. tubes and fittings, can comprise a readily available material resistant to the solar liquid, such as, for example, steel, corrosion-resistant metal alloys, coated materials, plastics, or combinations thereof. Preferably, the tubes are made of plastic.

In a preferred embodiment, the device additionally comprises a continuous-flow appliance in the solar heat store. This continuous-flow appliance can be used both for the withdrawal of stored solar liquid and for the supply of colder solar liquid.

In a suitable design, the continuous-flow appliance is arranged in the lower half of the solar heat store.

In a further suitable design, the distance of the withdrawal appliance from the continuous-flow appliance within the solar heat store, determined as length of the linear connection line, is at least 40%, preferably at least 50%, of the direct distance between the points furthest apart from one another on the inner wall of the solar heat store, determined as the length of the linear connection line of the two points.

In a preferred embodiment of the device according to the invention, the heat-insulating appliance is a floating body.

In an alternative embodiment of the device according to the invention, the heat-insulating appliance is firmly fixed.

Particularly preferably, the heat-insulating appliance is equipped on the side facing the solar heat store with a layer which reflects heat radiation.

Particularly preferably, the heat-insulating appliance is equipped on the side facing the solar collector with a layer that absorbs solar radiation.

In a preferred embodiment of the device according to the invention, the angle of inclination between the longitudinal axis of the device and the horizontal can be set in the range from 0° and 90°.

In an equally preferred embodiment of the device according to the invention, the device is orientated such that the solar collector plane has an azimuth angle in the range from −45° to +45°.

The energy yield of a solar thermal system depends quite generally on the angle of inclination of the solar collector and the azimuth angle. The energy yield of a solar thermal system is calculated to be the greatest when sunlight is incident on the solar collector at a right angle. The position of the sun changes with the seasons. A smaller angle of inclination has a beneficial effect in summertime, and a higher angle of inclination ensures better yields in winter. Generally, the angle of inclination of the solar collector should be in the range from 20° to 60°, preferably in the range from 30° to 45°.

The angle of inclination, here and hereinafter, denotes the angle between the longitudinal axis of the device and the horizontal. For simplification, the longitudinal axis of the base plate can also be taken to be the longitudinal axis of the device.

The azimuth angle describes the deviation of the collector plane from the south direction. An azimuth angle of 0° means that the collector plane is said to be orientated toward the south. Since the solar irradiation is most intense at midday, the collector plane should as far as possible be orientated toward the south. In general, a solar system in a purely southerly orientation, corresponding to an azimuth angle of 0°, produces the highest energy yields. In the case of an east or west orientation, only up to 85% of the maximum energy yield can be achieved. An azimuth angle in the range from −45° to +45° corresponds to a south-west to south-east orientation.

In a suitable embodiment of the device according to the invention, the solar heat store has internals for flow deflection. Suitable internals cause a flow deflection in the range from 90° to 180°. This should counteract a stable temperature layering in the solar liquid (thermocline).

In a preferred embodiment of the device according to the invention, the ratio of the fill volumes of solar collector to solar heat store is in the range from 1:5 to 1:500.

In a preferred embodiment of the device according to the invention, the solar heat store has a maximum fill volume in the range from 10⁻² m³ to 10⁵ m³.

In a preferred embodiment of the device according to the invention, the solar heat store has a ratio of surface area to fill volume in the range from 0.1 m⁻¹ to 600 m⁻¹.

In a preferred embodiment of the device according to the invention, the solar collector has a maximum fill height in the range from 1 mm to 500 mm.

The present invention further relates to an alternative process for solar-thermal energy production in which switching between daytime and nighttime operation is possible, in which, in the daytime operation
a solar liquid is provided continuously,
heat energy is fed by means of solar thermal power to the solar liquid provided, wherein the solar liquid is heated, and
the heated solar liquid is at least in part stored in a storage device, and in nighttime operation, the heated and stored solar liquid is continuously withdrawn from the storage device as heating medium. The heating and storage of the heated solar liquid proceeds in this case in a device according to the invention.

In a preferred design of this process, in nighttime operation
the same solar liquid as in the daytime operation is continuously provided,
the solar liquid provided is introduced into the storage device in such a manner that
the heated and stored solar liquid is displaced from the storage device and
continuously taken off as heating medium.

The invention also relates to the use of the device according to the invention and/or of the alternative process according to the invention for the production of drinking water and/or service water from microbially contaminated water.

The device according to the invention and/or the alternative process according to the invention can also be used for the production of drinking water and/or service water from saltwater.

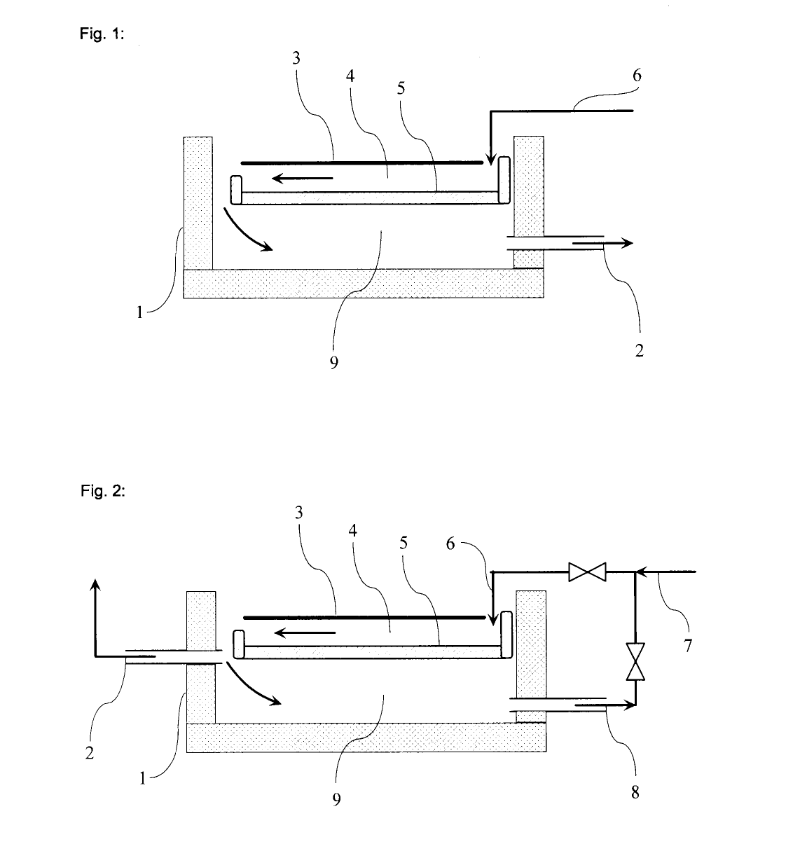

In FIGS. 1 to 5, suitable and preferred embodiments of devices according to the invention are shown. The embodiments shown serve for illustration and are not intended to restrict the invention thereto.

FIG. 1 shows schematically a simple embodiment of the device according to the invention.

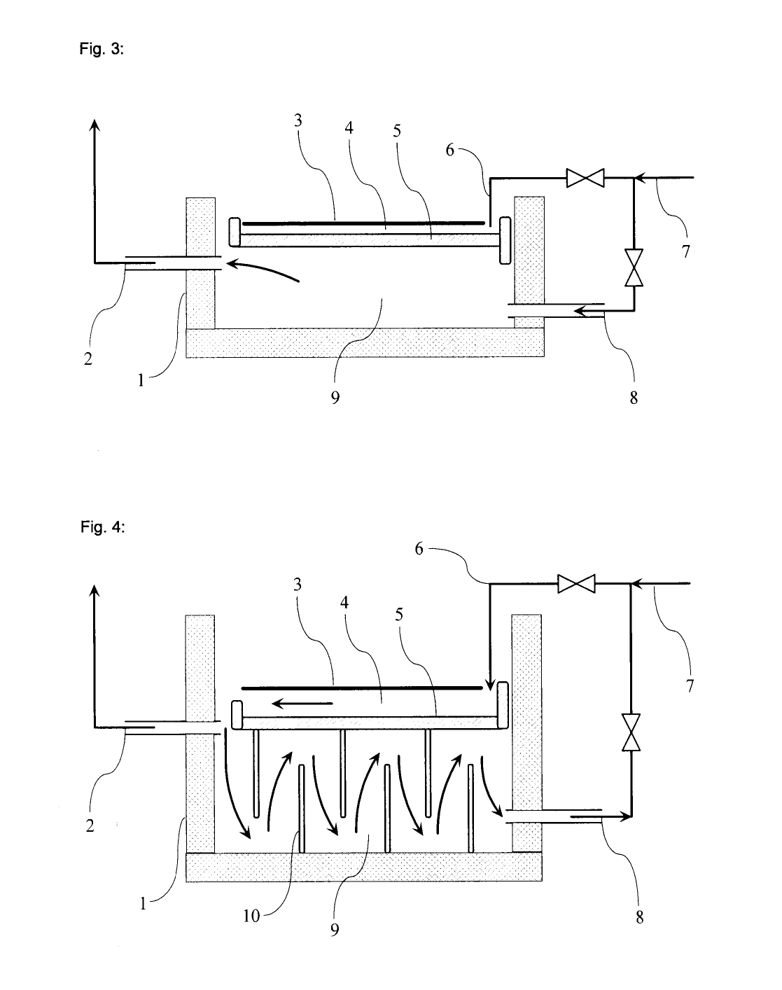

FIG. 2 shows a preferred embodiment of the device according to the invention in daytime operation.

FIG. 3 shows a preferred embodiment of the device according to the invention in nighttime operation.

FIG. 4 shows an embodiment of the device according to the invention with flow deflectors.

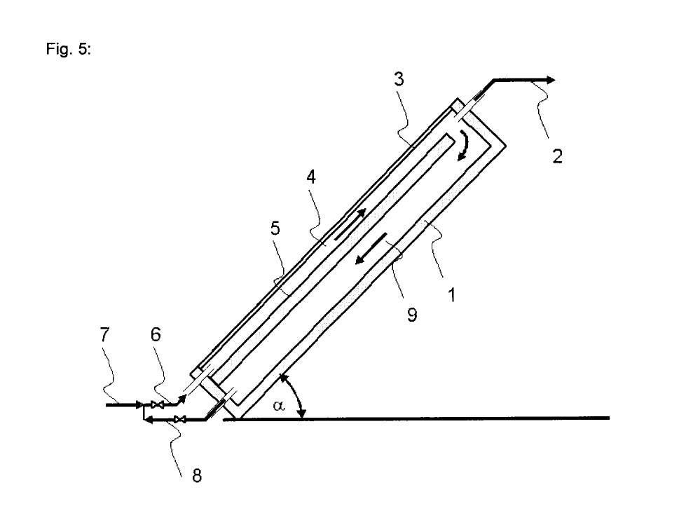

FIG. 5 shows an embodiment of the device according to the invention which is oriented toward the sun.

In the figures, the following reference signs are used:
1 Pool
2 Withdrawal for heated solar liquid
3 Covering
4 Solar collector
5 Heat-insulating appliance
6 Supply for solar liquid into the solar collector
7 Feed line for provided solar liquid
8 Continuous-flow appliance for withdrawal or supply of solar liquid from or into the (solar heat) store
9 Solar heat store
10 Flow deflector.

The device shown in FIG. 1 is a pool (1) filled with solar liquid. For the outer shape thereof, recesses present geologically or shapes created by corresponding clearance work can be used. The pool comprises a solar collector (4), here and hereinafter also termed heat collector, and a solar heat store (9). The pool is insulated in such a manner that heat losses to the surroundings are minimized. In addition, it is dimensioned in such a manner that for times without solar radiation, a corresponding store volume is available. The solar collector (4) and solar heat store (9) are separated from one another by a heat-insulating separating appliance (5). The separating appliance (5) can be floating or firmly anchored. The solar collector (4) is provided with a covering (3), which is permeable to heat radiation. The covering (3) is generally transparent and reduces energy losses by preventing uncontrolled evaporation of the water.

In daytime operation, relatively cold water flowing via a supply for solar liquid (6) into the solar collector (4) is heated between covering (3) and separating appliance (5) to temperatures in the range from 50° C. to 100° C. The heated water flows on into the solar heat store (9). There it is stored during the day, but can also in part be taken off via a withdrawal (2) as heated solar liquid. In nighttime operation, the stored heated solar liquid is withdrawn from the solar heat store (9) via the withdrawal (2).

In FIGS. 2 and 3, a preferred embodiment of the device according to the invention is shown in daytime operation and in nighttime operation. The daytime operation denotes times in this case at which the solar irradiation is intense enough in order to heat the water in the solar collector (4) to temperatures in the range from 50° C. to 100° C. The nighttime operation, in contrast, denotes times at which the solar irradiation is too low in order to heat the water in the solar collector (4) correspondingly.

FIG. 2 shows a solar collector (4) and a solar heat store (9), which are arranged in an insulated pool (1) separated from one another via a heat-insulating appliance (5). The heat-insulating appliance (5) is arranged to be floating. In the daytime operation, via a supply (6), solar liquid is fed into the region between the covering (3) and the heat-insulating appliance (5). There, the solar liquid is heated to temperatures up to 100° C. The heated solar liquid flows on into the solar heat store (9), where it is stored. Since the heat-insulating appliance (5) is arranged to be floating, it always lies directly on the stored hot solar liquid and is elevated by the increasing fill height thereof in the same extent. As a result, at each time point, an air layer over the solar liquid is effectively prevented. Via the withdrawal (2), optionally some of the heated solar liquid can be taken off directly as heating medium.

Possibly, the stored solar liquid is to be brought to a higher temperature level, such as, for example, in the start-up state or at times with less intense solar irradiation. For this purpose, heated solar liquid can be taken off via a continuous-flow appliance (8) from the solar heat store (9) in the lower region and fed together with the cooler solar liquid, which is provided by the feed line (7), via the supply (6) into the solar collector (4). Thus, the feed temperature of the solar liquid into the solar collector (4) can be set to a higher value.

FIG. 3 shows the same arrangement as FIG. 2 in nighttime operation. In the nighttime operation, the cooler solar liquid provided via the feed line (7) is fed into the lower region of the solar heat store (9) via the continuous-flow appliance (8). In this case, the cooler solar liquid displaces the stored heated solar liquid. Via the withdrawal (2), the stored heated solar liquid is withdrawn from the solar heat store (9). The heat-insulating appliance (5) descends again to the same extent in which the fill level of the stored solar liquid descends. At the start of the nighttime operation, the solar collector runs empty and also remains unfilled during the nighttime operation.

The withdrawal of the stored energy from the solar heat store (9) in the nighttime operation can proceed in various ways:

The heated solar liquid can be withdrawn from the solar heat store, without replacing the volume taken off by fresh cooler solar liquid. This mode of operation leads to a lowering of the fill level in the solar heat store. Accordingly, the fill level during the daytime operation is increased again. The fill level increase can proceed under temperature control, that is to say that the elevation of the fill level proceeds in dependence on the irradiated solar power and the temperature achievable therefrom of the heated solar liquid in the outlet of the solar collector into the solar heat store.

Alternatively, the heated solar liquid can be withdrawn from the solar heat store and simultaneously the volume taken off can be replaced by fresh, cooler solar liquid. In this mode of operation, the fill level is kept at a constant level. In this case, a spatial separation of the supply for solar liquid into the solar heat store (8) and the withdrawal for heated solar liquid (2) must be heeded, in order to prevent direct contact of incoming cool solar liquid with outflowing heated solar liquid. For this mode of operation, an elongate pool base shape and/or flow-deflecting internals in the solar heat store are advantageous. A suitable embodiment of the device according to the invention having flow deflectors (10) in the solar heat store (9) is shown by way of example in FIG. 4. For the embodiment shown in FIG. 4, the remaining explanations for FIGS. 2 and 3 apply.

Furthermore, it can be advantageous to allow the supply (8) and the withdrawal (2) to move. As a result, permanently cold regions in the solar heat store may be avoided, in which, in particular, there is the risk of algal overgrowth.

Of course, a mixed procedure also comes into consideration, in which the solar liquid which is taken off in the nighttime operation is in part replaced by fresh solar liquid.

In FIG. 5, a special embodiment of the device according to the invention is shown, which is oriented toward the sun.

A solar collector (4) and a solar heat store (9) are arranged in an insulated pool (1) separated from one another by a heat-insulating appliance (5). The heat-insulating appliance (5) in this case is firmly anchored. In the daytime operation, via a supply (6), solar liquid is supplied into the region between the covering (3) and the heat-insulating appliance (5). There, the solar liquid is heated. The heated solar liquid flows on into the solar heat store (9), where it is stored. Via a withdrawal (2), some of the heated solar liquid can be taken off directly as heating medium. In nighttime operation, the stored heated solar liquid is withdrawn from the solar heat store (9) via the withdrawal (2), without replacing the volume taken off by fresh solar liquid. A gradual empty running of the solar heat store (9) occurs.

In this embodiment also it is possible to bring the stored solar liquid to a higher temperature level. For this purpose, heated solar liquid can be taken off from the lower region of the solar heat store (9) via a continuous-flow appliance (8) and fed into the solar collector (4) via the supply (6) together with the cooler solar liquid which is provided via the feed line (7). The feed temperature of the solar liquid into the solar collector (4) can thus be adjusted to a higher level than the solar liquid provided via the feed line (7).

In the embodiment shown in FIG. 5, the angle of inclination of the solar collector, that is to say the angle of inclination between the longitudinal axis of the base plate of the pool (1) and the horizontal, can be adjusted in the range from 0° to 90°. In practice, it has proved to be sufficient to be able to adjust this angle, here and hereinafter also termed the angle of incidence, in a range from 20° to 60°, in particular from 30° to 45°. Optionally, the angle of incidence can be corrected during operation, and so adaptation to the solar height can be performed.

It cannot be seen from the figure that the device is oriented in such a manner that the solar collector plane has an azimuth angle in the range from −45° to +45°. This corresponds to a southwesterly to southeasterly orientation of the solar collector (4).

### EXAMPLE

### Round Pool

Solar collector area: 100 m²
Solar collector diameter: 11.3 m
Median solar irradiation: 250 W/m²
Median absorption power: 0.88·250 W/m²=220 W/m²
Heat losses=20% of median absorption power
Water temperature supply: 55° C.
Water temperature withdrawal: 65° C.
Amount of heatable water=36.4 m³/d
Median power of solar collector=17.6 kW

1. A process for solar thermal energy production in which switching between daytime and nighttime operation is possible,
the process comprising, in the daytime operation,
feeding heat energy by solar thermal power to a solar liquid which is continuously present and is heated,
taking off a part of the solar liquid heated in the feeding as heating medium,
storing a remaining part of the solar liquid heated in the feeding in a storage device, and
displaying a colder solar liquid from the storage device by the part of the heated solar liquid that is to be stored,
and, in the nighttime operation,
introducing the same solar liquid in the daytime operation which is continuously present into the storage device in such a manner that
the heated solar liquid obtained in the storing is displaced from the storage device and
is withdrawn as heating medium.

2. The method according to claim 1, wherein the solar liquid comprises substantially water.

3. The process according to claim 2, wherein the solar liquid has a salinity in the range from 0.5% to 30.0%.

4. The process according to claim 2, wherein the solar liquid is contaminated by suspended matter.

5. The process according to claim 2, wherein the solar liquid is contaminated by microorganisms.

6. The process according to claim 1, wherein the solar liquid, during the heating by solar thermal power, is heat-insulatingly covered from the surroundings in such a manner that energy input into the solar liquid by radiation is possible.

7. The process according to claim 1, wherein a fill height of the storage device can be controlled.

8. The process according to claim 1, wherein a fill height of a heat-absorbing region can be controlled.

9. The process according to claim 8, wherein a volume of a heat-absorbing region can be minimized in the nighttime operation.

10. The process according to claim 9, wherein the heat-absorbing region, in the daytime operation, has a fill height of not less than 1 mm of the solar liquid.

11. The process according to claim 1, wherein a heat-absorbing region is insulated from the storage device in such a manner that heat transfer between these regions can take place substantially only via the introduction of the solar liquid.

12. The process according to claim 1, wherein the solar liquid is deflected two or more times during flow through the storage device.

13. The process according to claim 1, wherein the solar liquid that is taken off in the daytime and nighttime operations as heating medium is fed to an appliance for decoupling utilizable heat.

14. The process according to claim 1, wherein the solar liquid displaced in the storing, after leaving the storage device, is returned at least in part in the feeding.

15. The process according to claim 1, wherein a fill level of the storage device is controlled in dependence on a temperature of the solar liquid.

16. The process according to claim 3, wherein the process is suitable for producing drinking water, service water, or both, from salt water.

17. The process according to claim 4, wherein the process is suitable for producing drinking water, service water, or both, from contaminated water.

18. A continuous process for producing pure water from raw water, comprising
passing a raw water comprising a non-vaporizable component as cooling medium into a heat exchanger,
additionally supplying heat according to a process according to claim 2, to the raw water heated in the heat exchanger,
feeding the raw water from the supplying to an evaporation zone,
contacting a carrier gas suitable for water vapor in the evaporation zone with the raw water in countercurrent, wherein the carrier gas takes up water vapor from the raw water to obtain a water vapor-loaded carrier gas,
enriching the raw water obtained in the contacting in the non-vaporizable component, and withdrawing the raw water from the evaporation zone,
feeding the water vapor-loaded carrier gas from the evaporation zone to the heat exchanger and cooling in countercurrent to the raw water, wherein the water vapor present in the carrier gas is in part condensed out,
passing out of the heat charger the carrier gas depleted in water vapor, and
taking off from the heat exchanger as pure water the water vapor that is condensed.

19. A device, comprising
an appliance for feeding a solar liquid;
a solar collector comprising a heat-insulating covering which is substantially permeable to solar radiation;
a solar heat store;
a heat-insulating appliance which separates the solar collector and the solar heat store from one another; and
an appliance for withdrawing the heated solar liquid;
wherein the solar collector is arranged directly above the solar heat store.

20. The device according to claim 19, additionally comprising
a continuous-flow appliance in the solar heat store which is suitable for both the withdrawal of stored solar liquid and for supplying colder solar liquid.

21. The device according to claim 19, wherein the heat-insulating appliance is a floating body.

22. The device according to claim 19, wherein the heat-insulating appliance is firmly fixed.

23. The device according to claim 19, wherein the heat-insulating appliance is equipped on a side facing the solar heat store with a layer which reflects the heat radiation.

24. The device according to claim 19, wherein the heat-insulating appliance, on a side facing the solar collector, is equipped with a layer that absorbs solar radiation.

25. The device according to claim 19, wherein an angle of inclination between a longitudinal axis of the device and a horizontal can be set in the range from 0° and 90°.

26. The device according to claim 19, wherein the device is orientated such that the solar collector plane has an azimuth angle in the range from −45° to +45°.

27. The device according to claim 19, wherein the solar heat store has internals for flow deflection.

28. The device according to claim 19, wherein the solar heat store is at least in part insulated from surroundings in side and lower regions.

29. The device according to claim 19, wherein a ratio of the fill volumes of solar collector to solar heat store is from 1:5 to 1:500.

30. The device according to claim 19, wherein the solar heat store has a maximum fill volume of from 10⁻² m³ to 10⁵ m³.

31. The device according to claim 19, wherein the solar heat store has a ratio of surface area to fill volume of from 0.1 m⁻¹ to 600 m⁻¹.

32. The device according to claim 19, wherein the solar collector has a maximum fill height of from 1 mm to 500 mm.

33. The device according to claim 19, wherein the solar liquid is substantially water.

34. A process for solar-thermal energy production in which switching between daytime and nighttime operation is possible,
comprising: in the daytime operation,
feeding heat energy by solar thermal power to a solar liquid which is continuously present and is heated, and
storing the heated solar liquid at least in part in a storage device, and, in the nighttime operation,
continuously taking off the heated and stored solar liquid from the storage device as heating medium;
wherein heating and storing of the heated solar liquid proceeds in a device according to claim 19.

35. The process according to claim 34, wherein the nighttime operation comprises
the same solar liquid as in the daytime operation, and
the solar liquid into the storage device in such a manner that
the heated and stored solar liquid is displaced from the storage device and
continuously taken off as heating medium.

36. The device according to claim 19, wherein the device is suitable for producing drinking water, service water, or both, from microbially contaminated water.

37. The device according to claim 19, wherein the device is suitable for producing drinking water, service water, or both, from salt water.
